(19) United States
(12) Patent Application Publication
(10) Pub. No.: US 2023/0356418 A1
(43) Pub. Date: Nov. 9, 2023

(54) CABLE GUIDED STRUCTURE AND MODULAR ROBOT WITH THE SAME

(71) Applicants: AGUILE ROBOTS AG, München (DE); Beijing Siling Robot Technology Co., Ltd., Beijing (CN)

(72) Inventors: Zhaopeng Chen, Beijing (CN); Xuebin Su, Beijing (CN); Qian Wang, Beijing (CN); Zhimin Gao, Beijing (CN); Peng Li, Beijing (CN); Juyuan Zhang, Beijing (CN)

(21) Appl. No.: 17/780,672

(22) PCT Filed: Nov. 17, 2020
(86) PCT No.: PCT/EP2020/082433

§ 371 Date: May 27, 2022

(30) Foreign Application Priority Data
Nov. 30, 2019 (CN) 201911208256

(51) Int. Cl. B25J 19/00; B25J 9/08

(52) U.S. Cl. CPC B25J 19/0029; B25J 9/08

(57) ABSTRACT

The invention discloses a cable guided structure comprising a threading portion, a guiding portion, and a mounting portion; wherein, the threading portion includes a threading hole surrounding wall, and a threading hole is formed in the threading hole surrounding wall, and the cable can be passed through the threading hole; the guiding portion forms into a long structure, and is used to guide the cable; the mounting portion is used to fix the cable guided structure to other components. The cable guided structure of the present invention can fix the cables in the narrow space of the robot arm, and prevents the cable from rubbing against other components, and also prevent the cables from moving or abrasion during moving of the robot arm.

### FIELD OF THE INVENTION

The invention relates to the field of modular robot, in particular to an internal structure of the modular robot.

### BACKGROUND OF THE INVENTION

In the prior art, a ribbon is often used for fixing the cable in the mechanical arm of the modular robot without cable guided structure. There is a disadvantage that the cables inside the robot arm joint are easy to wear, and the cables cannot be firmly fixed in some small spaces of the robot arm, and the cables are easy to move or wear with the hole wall, thereby the life and safety of the robot are affected.

### SUMMARY OF THE INVENTION

It is an object of the invention to solve at least one of problems of the prior art and provides a cable guided structure comprising a threading portion, a connecting bridge, and a mounting portion; the threading portion includes a threading hole surrounding wall, and a threading hole is formed in the threading hole surrounding wall, and the cable can be passed through the threading hole; the connecting bridge forms into a long structure, and the connecting bridge connects the mounting portion and the threading portion; the mounting portion is used to fix the cable guided structure to other components; the mounting portion includes two fixing portions and a connecting portion, the connecting portion connects the two fixing portions, the cable can pass through a channel formed in the mounting portion.

The present invention also provides a cable guided structure comprising a threading portion, a guiding portion, and a mounting portion; the threading portion includes a threading hole surrounding wall, and a threading hole is formed in the threading hole surrounding wall, and the cable can be passed through the threading hole; the guiding portion forms into a long structure, a groove is formed in the guiding portion, at least a part of the cable can be accommodated in the groove, the guiding portion is used to guide the cable; the guiding portion connects the mounting portion and the threading portion; the mounting portion is used to fix the cable guided structure to other components.

Further, the guiding portion includes a guiding portion bottom plate and a guiding portion vertical wall, the guiding portion vertical wall extends upward from the guiding portion bottom plate, a groove is formed in the area enclosed by the guiding portion bottom plate and the guiding portion vertical wall.

Further, the threading portion is further provided with a threading portion vertical wall, the threading portion vertical wall extends from the threading hole surrounding wall in a direction parallel to the axis of the threading hole.

Further, a through hole is formed in the mounting portion, a connecting member can be accommodated in the through hole, and the connecting member connects the mounting portion to other components.

Further, the thickness of the guiding portion vertical wall gradually increases and then gradually decreases along the length of the guiding portion, thereby a narrow portion (A) for holding the cable is formed.

Further, a cable restrained hole is formed in the mounting portion, the number of the cable restrained holes is two, and the cable restrained holes are located on both sides of the groove, and the cable restrained hole can accommodate a cable restrained structure, the cable restrained structure is used to fix a cable.

Further, a cable guided structure further comprises a cable sleeve, the cable sleeve is connected to the guiding portion, and the cable sleeve is a closed structure, and the cable can pass through the cable sleeve.

Further, the mounting portion is connected to the guiding portion or the cable sleeve or the threading portion through a supporting portion.

Further, the cable sleeve is provided with an opening (85a), and the number of the opening is one or more.

Further, a material reducing hole is provided on the supporting portion.

The present invention also provides a cable guided structure comprising a threading portion, a guiding portion, and a threading portion fixing portion; the threading portion includes a threading hole surrounding wall, and a threading hole is formed in the threading hole surrounding wall, and the cable can be passed through the threading hole; the guiding portion forms into a long guide structure, and a groove is formed in the guide structure, at least a part of the cable can be accommodated in the groove, the guide structure is used to guide the cable; the threading portion fixing portion is formed around the threading portion and includes a circumferential plate and a spoke, the spoke connects the threading portion and the circumferential plate, the number of spokes is two or three, or more than three.

Further, a supporting portion is provided between the threading portion fixing portion and the guiding portion.

Further, a material reducing hole is provided in the supporting portion.

Further, the threading portion is further provided with a threading portion vertical wall, the threading portion vertical wall extends from the threading hole surrounding wall in a direction parallel to the axis of the threading hole.

The present invention also provides a cable guided structure comprising a threading portion and a mounting portion; the threading portion includes a threading hole surrounding wall, and a threading hole is formed in the threading hole surrounding wall, and the cable can be passed through the threading hole; the threading portion is further provided with a threading portion vertical wall, the threading portion vertical wall extends from the threading hole surrounding wall in a direction parallel to the axis of the threading hole; a vertical wall protrusion is formed on a part of the threading portion vertical wall, the vertical wall protrusion has a higher height in the axial direction than the threaded portion vertical wall; the vertical wall protrusion is provided with a vertical wall cable passing hole, and a cable can pass through the vertical wall cable passing hole.

The present invention also provides a modular robot comprising a joint and a connecting rod, wherein the output flange of the joint is provided with the cable guided structure as described above, and the cable guided structure is used to guide and fix cables.

The cable guided structure of the present invention can fix the cables in the narrow space of the robot arm, and prevents the cable from rubbing against other components, and also prevent the cables from moving or abrasion during moving of the robot arm.

### BRIEF DESCRIPTION OF THE DRAWINGS

The above-mentioned and/or additional aspects and advantages of the present invention will become apparent and easily understood from the description of the embodiments with the following drawings, wherein:

FIG. 1 is a schematic cross-sectional view of a modular robot joint according to the invention.

FIG. 2 is a schematic view of a cable guided structure provided by embodiment 1 according to the invention.

FIG. 3 is a schematic view of a cable guided structure provided by embodiment 2 according to the invention.

FIG. 4 is a schematic view of a cable guided structure with the a cable restrained structure according to the embodiment 2 of the invention.

FIG. 5 is a schematic view of a cable restrained structure according to the invention.

FIG. 6 is a schematic view of a cable guided structure provided by embodiment 3 according to the invention.

FIG. 7 is a schematic view of a cable guided structure provided by embodiment 4 according to the invention.

FIG. 8 is a schematic view of a cable guided structure provided by embodiment 5 according to the invention.

FIG. 9 is a schematic view of a cable guided structure provided by embodiment 6 according to the invention.

Wherein, 7—cable, 8—cable guided structure, 81—threading portion; 81a—threading hole; 81b—threading hole surrounding wall; 81c—threading portion vertical wall; 82—connecting bridge; 822—guiding portion; 822a—guiding portion bottom plate; 822b—guiding portion vertical wall; 83—mounting portion; 83a—supporting portion; 831—fixing portions; 832—connecting portion; 84—cable restrained hole; 841—cable restrained structure; 844—material reducing hole; 85—cable sleeve; 85a—opening; 86—threading portion fixing portion; 86a—circumferential plate; 86b—spoke; 88—vertical wall protrusion; 89—vertical wall cable passing hole.

### DETAILED DESCRIPTION OF THE PREFERRED EMBODIMENTS

Hereinafter, embodiments of the present invention will be described in detail. Examples of the embodiments are shown in the accompanying drawings, wherein the same or similar reference numerals refer to the same or similar elements or elements having the same or similar functions throughout. The embodiments described below with reference to the drawings are exemplary and are only used to explain the present invention, but should not be construed as limitation to the present invention.

In the description of the present invention, the terms like “vertical”, “lateral”, “up”, “down”, “front”, “back”, “left”, “right”, “vertical”, “horizontal”, “top”, “bottom” and the like which indicate orientation or positional relationship indicate the orientation or positional relationship shown in the drawings, and the above-mentioned terms are used only to facilitate the description of the invention instead of requiring the present invention to be constructed and operated in a specific orientation. It cannot be understood as a limitation to the present invention.

In addition, in the description of the present invention, it should be noted that the terms like “installation”, “connect”, and “concatenate” should be construed in a broad way unless the meanings of above-mentioned terms are clear, for example, the above-mentioned terms can be a mechanical connection, or an electrical connection, or a direct connection, or indirect connection which is achieved by an intermediate medium, or an internal connection of two components. For the one skilled in the art, the specific meanings of the above terms in the present invention can be understood in accordance with specific conditions.

Further, it is understood that the description of any methods below, and a flowchart or the description of any process or method otherwise described herein indicate that they include module, fragment or part, which can execute instruction, including one or more steps for implementing a specific logical function or process, and the scope of a preferred embodiment of the present invention includes additional implementations, which may not be in the order shown or discussed, which should be understood by the one skilled in the art to which the embodiments of the present invention belong.

A logic and/or steps described in a flowchart or otherwise described herein, for example, can be a sequenced list of executable instructions that can be considered to implement a logical function, can be embodied in any computer-readable medium for using by an instruction execution system, equipment, or device (such as a computer-based system, a system including a processor, or other system that can fetch and execute instructions from an instruction execution system, equipment, or device), or for using with an instruction execution system, equipment, or device. A “computer-readable medium” may be any device that can contain, store, communicate, propagate, or transmit a program for using by an instruction execution system, apparatus, or device, or for using with an instruction execution system, apparatus, or device according to the invention. More specific examples (non-exhaustive list) of computer-readable media include the following: electrical connections (electronic devices) with one or more wirings, portable computer disk enclosures (magnetic devices), random access memory (RAM), read-only memory (ROM), erasable and editable read-only memory (EPROM or flash memory), fiber optic devices, and portable optical disk read-only memory (CDROM). In addition, the computer-readable medium may even be paper or other suitable medium on which the program can be printed, because, for example, the program can be obtained by optically scanning the paper or other medium, followed by editing, interpreting, or other suitable processing, and then stored in computer memory.

It should be understood that each part of the present invention may be implemented by hardware, software, firmware, or a combination thereof. In the above embodiments, multiple steps or methods may be implemented by software or firmware stored in a memory and executed by a suitable instruction execution system.

### Embodiment 1

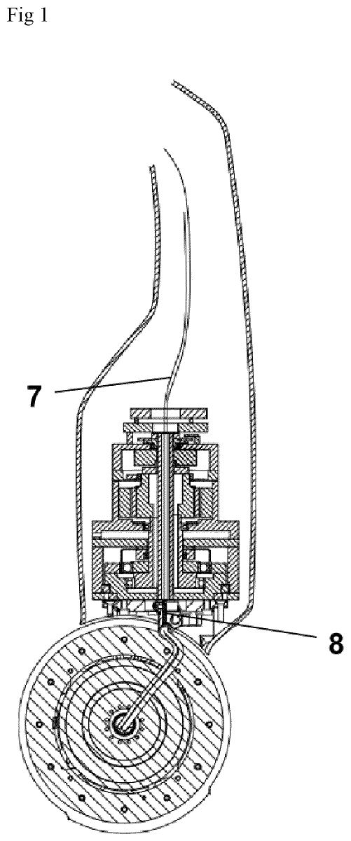

FIG. 1 shows a modular robot joint, and a cable guided structure 8 is provided at an output flange of the joint.

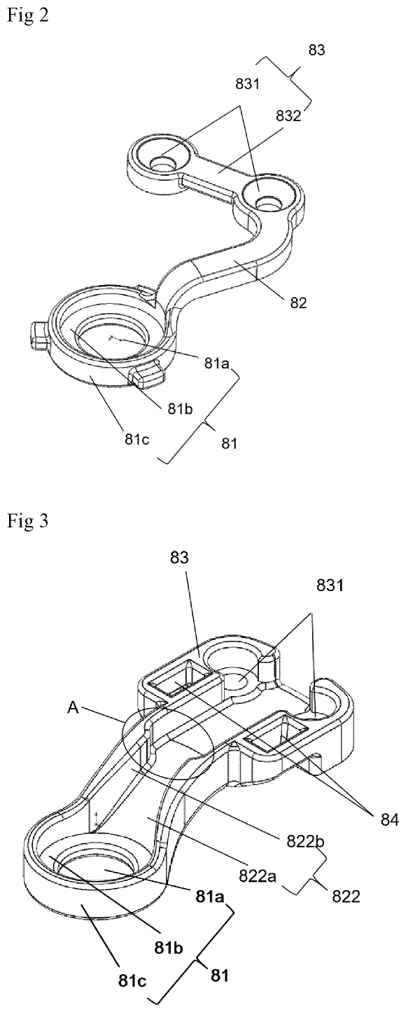

As shown in FIG. 2, this embodiment discloses a cable guided structure 8 used in the modular robot shown in FIG. 1.

The cable guided structure 8 includes a threading portion 81, a connecting bridge 82, and a mounting portion 83.

The threading portion 81 includes a threading hole surrounding wall 81b, and a threading hole 81a is formed in the threading hole surrounding wall 81b, and the cable can be passed through the threading hole 81a.

The connecting bridge 82 forms into a long structure, and the connecting bridge 82 connects the mounting portion 83 and the threading portion 81.

The mounting portion 83 is used to fix the cable guided structure to other components, for example, to the motor housing or other fixing components.

The mounting portion 83 includes two fixing portions 831 and a connecting portion 832. The connecting portion 832 connects the two fixing portions 831. The cable 7 can pass through a channel formed in the mounting portion 83, and be stably bound by the mounting portion 83.

The threading portion 81 is further provided with a threading portion vertical wall 81c, which extends from the threading hole surrounding wall 81b in a direction parallel to the axis of the threading hole 81a.

In this embodiment, a through hole is formed in the fixing portion 831, and a connecting member can be accommodated in the through hole, and the connecting member connects the mounting portion 83 to other components. The connecting member may be a screw.

The threading portion vertical wall 81c is further provided with a plurality of small protrusions, which enable the cable guided structure to be fixed to other components. The small protrusions can reduce consumables compared with a complete ring structure.

### Embodiment 2

As shown in FIG. 3, this embodiment discloses another cable guided structure 8.

The cable guided structure 8 includes a threading portion 81, a guiding portion 822, and a mounting portion 83.

The threading portion 81 includes a threading hole surrounding wall 81b, and a threading hole 81a is formed in the threading hole surrounding wall 81b, and the cable can be passed through the threading hole 81a. The guiding portion 822 forms into a long structure. A groove is formed in the guiding portion 822, at least a part of the cable can be accommodated in the groove, the guiding portion 822 is used to guide the cable. The guiding portion 822 connects the mounting portion 83 and the threading portion 81. A fixing portion 831 is provided in the mounting portion 83, and a through hole is formed in the fixing portion 831. A connecting member can pass through the through hole, and the connecting member is used to fix the cable guided structure to other components.

The guiding portion 822 includes a guiding portion bottom plate 822a and a guiding portion vertical wall 822b. The guiding portion vertical wall 822b extends upward from the guiding portion bottom plate 822a. A groove is formed in the area enclosed by the guiding portion bottom plate 822a and the guiding portion vertical wall 822b.

The thickness of the guiding portion vertical wall 822b gradually increases and then gradually decreases along the length of the guiding portion, thereby a narrow portion A for holding the cable is formed.

A cable restrained hole 84 is formed in the mounting portion 83. There are two the cable restrained holes 84 which are located on both sides of the groove, and the cable restrained hole 84 can accommodate a cable restrained structure 841, the cable restrained structure 841 is used to fix ( [symbol] ) a cable.

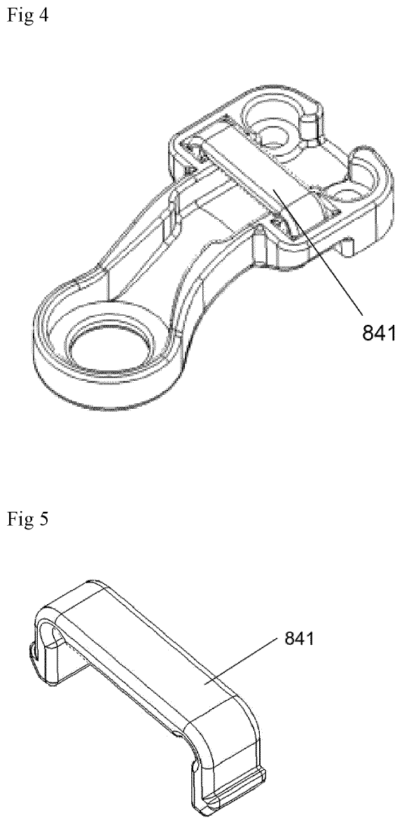

The cable restrained structure 841 may be a ribbon or a specially designed structure. As shown in FIGS. 3-4, the cable is fixed by cooperating the cable restrained structure 841 with the cable restrained hole 84.

The threading portion 81 is further provided with a threading portion vertical wall 81c, the threading portion vertical wall 81c extends from the threading hole surrounding wall 81b in a direction parallel to the axis of the threading hole 81a.

### Embodiment 3

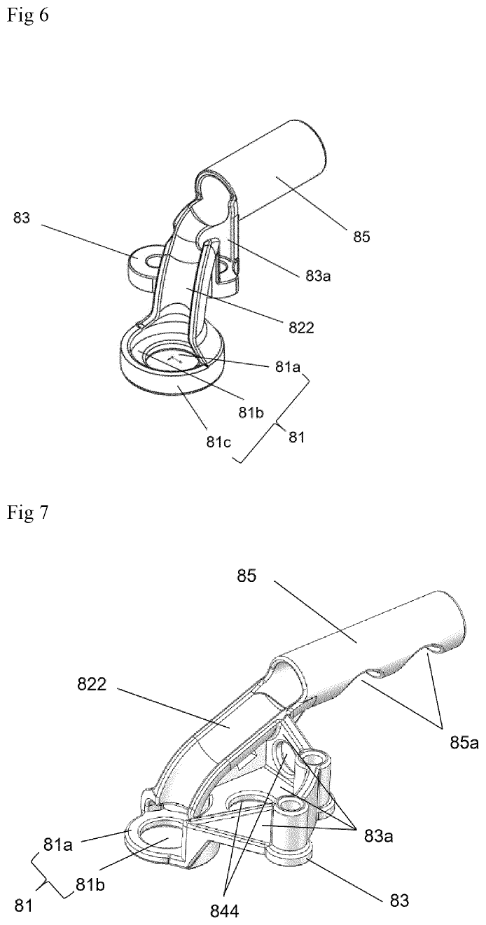

As shown in FIG. 6, this embodiment discloses another cable guided structure 8.

The cable guided structure 8 includes a threading portion 81, a guiding portion 822, and a mounting portion 83.

The threading portion 81 includes a threading hole surrounding wall 81b, and a threading hole 81a is formed in the threading hole surrounding wall 81b, and the cable can be passed through the threading hole 81a.

One end of the guiding portion 822 is connected to a cable sleeve 85, the cable sleeve 85 is a closed structure through which a cable can pass.

The mounting portion 83 is connected to the guiding portion 822 or the cable sleeve 85 or a connection area of the guiding portion 822 and the cable sleeve 85 through a supporting portion 83a, so as to support the guiding portion and the cable sleeve.

### Embodiment 4

As shown in FIG. 7, this embodiment discloses another cable guided structure 8.

Compared with the embodiment 3, the cable sleeve 85 of the cable guided structure 8 in this embodiment is provided with an opening 85a, and the number of the opening 85a is one or more. The effect of the opening 85a is to reduce consumables on the one hand, and to guide the cable to pass through the opening 85a on the other hand, that is, when the cable passes through the cable sleeve 85, a tool can be used to guide the cable to pass through the opening 85a.

The opening 85a may be provided at the side or top of the cable sleeve 85, so as to guide the cable to pass through the opening 85a, The opening may be provided at the starting section, the middle section and the like of the guiding portion so as to facilitate threading.

The ratio of the length of the closed portion of the cable sleeve 85 to the length of the open portion that is not closed is related to the diameter and the bending radius of the cable. The length of the open portion that is not closed is more than 5 times the cable diameter and more than 1 times the bending radius. The size of the opening of the open portion that is not closed depends on the threading tool and the diameter of the cable, and it is preferably more than twice the diameter of the cable.

In this embodiment, a supporting portion 83a is provided between the mounting portion 83 and the guiding portion, and between the mounting portion 83 and the threading portion, and a material reducing hole 844 is provided on the supporting portion 83a.

### Embodiment 5

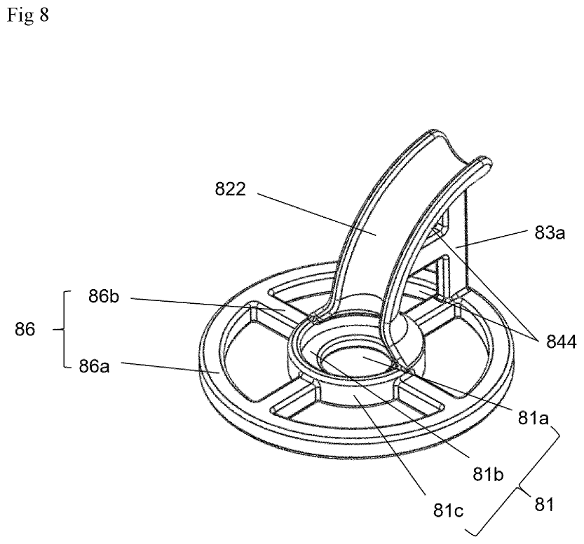

As shown in FIG. 8, this embodiment discloses another cable guided structure 8.

The cable guided structure 8 includes a threading portion 81, a guiding portion 822, and a threading portion fixing portion 86.

The threading portion 81 includes a threading hole surrounding wall 81b, and a threading hole 81a is formed in the threading hole surrounding wall 81b, and the cable can be passed through the threading hole 81a.

The guiding portion 822 forms into a long guide structure, and a groove is formed in the guide structure. At least a part of the cable can be accommodated in the groove. The guide structure is used to guide the cable.

The threading portion fixing portion 86 is formed around the threading portion 81 and includes a circumferential plate 86a and a spoke 86b. The spoke 86b connects the threading portion 81 and the circumferential plate 86a. The number of spokes 86b is two or three, or more than three.

A supporting portion 83a is provided between the threading portion fixing portion 86 and the guiding portion 822.

A material reducing hole 844 is provided in the supporting portion 83a. The material reducing hole 844 here is a rectangular hole and has a relatively large area, so a ribbon or a specially designed the cable restrained structure can pass through the material reducing hole 844, so as to achieve the effect of fixing the cable.

The threading portion 81 is further provided with a threading portion vertical wall 81c, the threading portion vertical wall 81c extends from the threading hole surrounding wall 81b in a direction parallel to the axis of the threading hole 81a.

### Embodiment 6

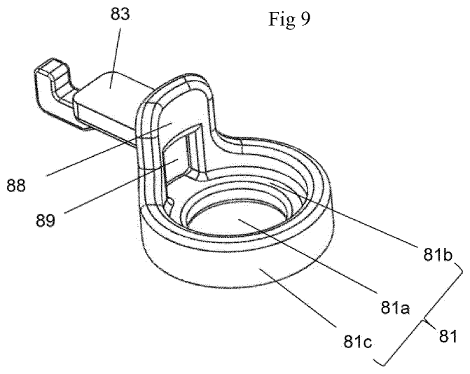

As shown in FIG. 9, this embodiment discloses another cable guided structure 8.

The cable guided structure 8 includes a threading portion 81 and a mounting portion 83. The threading portion 81 includes a threading hole surrounding wall 81b, and a threading hole 81a is formed in the threading hole surrounding wall 81b, and the cable can be passed through the threading hole 81a.

The threading portion 81 is further provided with a threading portion vertical wall 81c, which extends from the threading hole surrounding wall 81b in a direction parallel to the axis of the threading hole 81a.

A vertical wall protrusion 88 is formed on a part of the threading portion vertical wall 81c. The vertical wall protrusion 88 has a higher height in the axial direction than the threaded portion vertical wall 81c.

The vertical wall protrusion 88 is provided with a vertical wall cable passing hole 89, and a cable can pass through the vertical wall cable passing hole 89 and then pass through the threading hole 81a.

### Embodiment 7

This embodiment discloses a modular robot, which includes a joint and a connecting rod, and the output flange of the joint is provided with the cable guided structure 8 according to the first to sixth embodiments, and the cable guided structure 8 is used to guide and fix cables.

In the description of this specification, the terms “one embodiment”, “some embodiments”, “examples”, “specific examples”, or “some examples” and the like means specific features described in conjunction with the embodiments or examples, structure, materials or features are included in at least one embodiment or example of the present invention. In this specification, the schematic expressions of the above terms do not necessarily refer to the same embodiment or example. Moreover, the particular features, structures, materials, or characteristics described may be combined in any suitable manner in any one or more embodiments or examples. Although the embodiments of the present invention have been shown and described, those of ordinary skill in the art can understand that various changes, modifications, replacements, and substitutions of these embodiments can be made without departing from the principles and purposes of the present invention. The scope of the invention is defined by the claims and their equivalents.

What is claimed is:

1. A cable guided structure, which is characterized by comprising a threading portion (81), a connecting bridge (82), and a mounting portion (83);
the threading portion (81) includes a threading hole surrounding wall (81b), and a threading hole (81a) is formed in the threading hole surrounding wall (81b), and the cable can be passed through the threading hole (81a);
the connecting bridge (82) forms into a long structure, and the connecting bridge (82) connects the mounting portion (83) and the threading portion (81);
the mounting portion (83) is used to fix the cable guided structure to other components;
the mounting portion (83) includes two fixing portions (831) and a connecting portion (832), the connecting portion (832) connects the two fixing portions (831), the cable (7) can pass through a channel formed in the mounting portion (83).

2. A cable guided structure, which is characterized by comprising a threading portion (81), a guiding portion (822), and a mounting portion (83);
the threading portion (81) includes a threading hole surrounding wall (81b), and a threading hole (81a) is formed in the threading hole surrounding wall (81b), and the cable can be passed through the threading hole (81a);
the guiding portion (822) forms into a long structure, a groove is formed in the guiding portion (822), at least a part of the cable can be accommodated in the groove, the guiding portion (822) is used to guide the cable;
the guiding portion (822) connects the mounting portion (83) and the threading portion (81);
the mounting portion (83) is used to fix the cable guided structure to other components.

3. A cable guided structure of claim 2, characterized in that the guiding portion (822) includes a guiding portion bottom plate (822a) and a guiding portion vertical wall (822b), the guiding portion vertical wall (822b) extends upward from the guiding portion bottom plate (822a), a groove is formed in the area enclosed by the guiding portion bottom plate (822a) and the guiding portion vertical wall (822b).

4. A cable guided structure of claim 1 or 2, characterized in that the threading portion (81) is further provided with a threading portion vertical wall (81c), the threading portion vertical wall (81c) extends from the threading hole surrounding wall (81b) in a direction parallel to the axis of the threading hole (81a).

5. A cable guided structure of claim 1 or 2, characterized in that a through hole is formed in the mounting portion (83), a connecting member can be accommodated in the through hole, and the connecting member connects the mounting portion (83) to other components.

6. A cable guided structure of claim 3, characterized in that the thickness of the guiding portion vertical wall (822b) gradually increases and then gradually decreases along the length of the guiding portion, thereby a narrow portion A for holding the cable is formed.

7. A cable guided structure of claim 2, characterized in that a cable restrained hole (84) is formed in the mounting portion (83), the number of the cable restrained holes (84) is two, and the cable restrained holes (84) are located on both sides of the groove, and the cable restrained hole (84) can accommodate a cable restrained structure (841), the cable restrained structure (841) is used to fix a cable.

8. A cable guided structure of claim 2, further comprises a cable sleeve (85), the cable sleeve (85) is connected to the guiding portion (822), and the cable sleeve (85) is a closed structure, and the cable can pass through the cable sleeve (85).

9. A cable guided structure of claim 8, characterized in that the mounting portion (83) is connected to the guiding portion (822) or the cable sleeve (85) or the threading portion (81) through a supporting portion (83a).

10. A cable guided structure of claim 8, characterized in that the cable sleeve (85) is provided with an opening (85a), and the number of the opening (85a) is one or more.

11. A cable guided structure of claim 9, characterized in that a material reducing hole (844) is provided on the supporting portion (83a).

12. A cable guided structure, which is characterized by comprising a threading portion (81), a guiding portion (822), and a threading portion fixing portion (86);
the threading portion (81) includes a threading hole surrounding wall (81b), and a threading hole (81a) is formed in the threading hole surrounding wall (81b), and the cable can be passed through the threading hole (81a);
the guiding portion (822) forms into a long guide structure, and a groove is formed in the guide structure, at least a part of the cable can be accommodated in the groove, the guide structure is used to guide the cable;
the threading portion fixing portion (86) is formed around the threading portion (81) and includes a circumferential plate (86a) and a spoke (86b), the spoke (86b) connects the threading portion (81) and the circumferential plate (86a), the number of spokes (86b) is two or three, or more than three.

13. A cable guided structure of claim 12, characterized in that a supporting portion (83a) is provided between the threading portion fixing portion (86) and the guiding portion (822).

14. A cable guided structure of claim 13, characterized in that a material reducing hole (844) is provided in the supporting portion (83a).

15. A cable guided structure of claim 12, characterized in that the threading portion (81) is further provided with a threading portion vertical wall (81c), the threading portion vertical wall (81c) extends from the threading hole surrounding wall (81b) in a direction parallel to the axis of the threading hole (81a).

16. A cable guided structure, which is characterized by comprising a threading portion (81) and a mounting portion (83);
the threading portion (81) includes a threading hole surrounding wall (81b), and a threading hole (81a) is formed in the threading hole surrounding wall (81b), and the cable can be passed through the threading hole (81a);
the threading portion (81) is further provided with a threading portion vertical wall (81c), the threading portion vertical wall (81c) extends from the threading hole surrounding wall (81b) in a direction parallel to the axis of the threading hole (81a);
a vertical wall protrusion (88) is formed on a part of the threading portion vertical wall (81c), the vertical wall protrusion (88) has a higher height in the axial direction than the threaded portion vertical wall (81c);
the vertical wall protrusion (88) is provided with a vertical wall cable passing hole (89), and a cable can pass through the vertical wall cable passing hole (89).

17. A modular robot comprising a joint and a connecting rod, wherein the output flange of the joint is provided with the cable guided structure (8) according to any one of claims 1-16, and the cable guided structure (8) is used to guide and fix cables.
